(19) United States
(12) Patent Application Publication
(10) Pub. No.: US 2026/0004325 A1
(43) Pub. Date: Jan. 1, 2026

(54) IDENTIFYING A TARGET CONTENT ITEM GROUP USING OFFLINE EMBEDDING BASED RETRIEVAL

(71) Applicant: Microsoft Technology Licensing, LLC, Redmond, WA (US)

(72) Inventors: Zian ZHAO, Santa Clara, CA (US); Yu LIU, Sunnyvale, CA (US); Shao TANG, Cupertino, CA (US); Jacqueline MORRIS, New York, NY (US); Atul UGALMUGALE, San Ramon, CA (US); Jingtao TONG, Sunnyvale, CA (US); Yi WU, Stanford, CA (US); Xiaowen ZHANG, San Francisco, CA (US); Jae OH, Burlingame, CA (US); Luke KOPAKOWSKI, San Francisco, CA (US); Jing WANG, Mountain View, CA (US); Haifeng ZHAO, Mountain View, CA (US)

(21) Appl. No.: 18/759,564

(22) Filed: Jun. 28, 2024

(51) Int. Cl. G06Q 30/0251; G06Q 30/0204

(52) U.S. Cl. CPC G06Q 30/0269; G06Q 30/0205; G06Q 30/0255

(57) ABSTRACT

The present disclosure relates to systems, non-transitory computer-readable media, and methods for generating a content item group comprising members that have interest in a content item. In particular, the disclosed systems can generate a member embedding by leveraging member activity feature data and member information feature data. The disclosed systems can further generate a content item embedding reflecting content item feature data. The disclosed systems may generate a similarity score between the member embedding and the content item embedding. Based on the similarity score meeting a threshold similarity score, the disclosed system can determine to include a member within a target content item group.

### BACKGROUND

Recent years have seen significant improvements in technology for advertisers aiming to reach specific audiences interested in their products or services. In particular, recent technology advancements enable advertisers to leverage data analytics, machine learning, and artificial intelligence to precisely identify and segment potential customers based on their online behaviors, preferences, and demographics. Some existing advertising systems attempt to analyze vast amounts of data from various sources including social media interactions, browsing histories, purchase patterns, and other digital footprints to predict detailed audience profiles. Advertisers can use data to deliver personalized and relevant content to individuals most likely to engage with their products or services. Existing systems are required to more efficiently leverage growing amounts of data to efficiently pair advertisers and potential customers.

These along with additional problems and issues exist with regard to conventional advertising systems.

### SUMMARY

Embodiments of the present disclosure provide benefits and/or solve one or more of the foregoing or other problems in the art with systems, non-transitory computer-readable media, and methods for identifying a specific audience who is interested in a particular content item. In particular, the disclosed system trains and utilizes a two-tower model that calculates similarities between a member and a content item. More specifically, as part of assessing a member, the disclosed system leverages member data including member activities and member information. The disclosed system can combine the member activities and member information to generate a member embedding. The disclosed system further compares the member embedding with a content item embedding to generate a similarity score indicating a similarity between the member embedding and the content item embedding. The disclosed system can create a group of members having a similarity score that satisfies a threshold similarity score.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a schematic diagram of an example system environment for implementing a target content item group generation system in accordance with one or more embodiments.

FIGS. 2A-2B illustrate the target content item group generation system determining a target content item group in accordance with one or more embodiments.

FIG. 3 illustrates the target content item group generation system modifying parameters of the member activity model, the member information model, the content item model, and the member embedding model in accordance with one or more embodiments of the present disclosure.

FIG. 4 illustrates a table including details for example feature data for the member and content items that the target content item group generation system uses to generate the member embedding and the content item embedding in accordance with one or more embodiments.

FIGS. 5A-5B illustrate an alternative classification model that generates a target content item group based on sales data and marketing data in accordance with one or more embodiments of the present disclosure.

FIGS. 6A-6C illustrate a series of example content item management user interfaces for managing content items and target content item groups in accordance with one or more embodiments.

FIG. 7 illustrates an example series of acts for generating a target content item group using a member activity embedding model, a member information model, and a content item model in accordance with one or more embodiments.

FIG. 8 illustrates a block diagram of an example computing device for implementing one or more embodiments of the present disclosure.

FIG. 9 illustrates an example large language model in accordance with one or more implementations.

### DETAILED DESCRIPTION

This disclosure describes one or more embodiments of a target content item group generation system that identifies a target content item group comprising members that are likely to be interested in a particular content item. More specifically, the target content item group comprises members within an entity that would be interested in a particular content item on behalf of the entity. The target content item group generation system can leverage a variety of machine learning models to determine similarities between content items and members. For instance, the target content item group generation system can evaluate member activity features and member information text to generate a member embedding. The target content item group generation system can further analyze content item information to generate a content item embedding. The target content item group generation system compares the member embedding with the content item embedding to determine a similarity between the two embeddings. More similar embeddings likely indicate a higher member interest in the content item.

In particular, the target content item group generation system uses a member information model to generate a member information embedding that reflects text within a member information of a member. The target content item group generation system can further use a member activity model to generate a member activity embedding reflecting member activity data. The target content item group generation system can also use a member embedding model to generate a member embedding based on the member information embedding and the member activity embedding. In some embodiments, the target content item group generation system can use a content item model to generate a content item embedding reflecting information about a content item. In some implementations, the target content item group generation system determines a similarity score indicating a similarity between the content item embedding and the member embedding. The target content item group generation system can include the member in a target content item group corresponding to the content item based on determining that the similarity score satisfies a threshold similarity score.

As mentioned, the target content item group generation system identifies members of a target content item group. In some examples, the target content item group generation system identifies a content item group within a business-to-business (B2B) setting. In particular, members of a target content item group may comprise stakeholders within an entity that would show interest in a particular content item on behalf of the entity. In addition to identifying members having an individual interest in content items, as in a business-to-consumer (B2C) setting, the target content item group generation system can identify a target content item group within an entity comprising multiple members—each with different roles, responsibilities, and criteria that impact the decision-making of an entity. The target content item group generation system can identify members within an entity that are involved in an entity's decision-making and interest in a given content item.

As mentioned previously, the target content item group generation system can generate a member embedding. More particularly, the target content item group generation system can use various machine learning models to leverage a plurality of member features to generate the member embedding. In some examples, the target content item group generation system uses a member information model to analyze member information to generate a member information embedding. Furthermore, the target content item group generation system can use a member activity model to analyze member activity (e.g., interactions with advertisements) to generate a member activity embedding. Additionally, the target content item group generation system can generate a member outreach embedding indicating marketing and sales outreach that have targeted the member. The target content item group generation system can, in some implementations, use a member embedding model to generate a member embedding based on the member information embedding, the member activity embedding, and the member outreach embedding.

The target content item group generation system can further generate a content item embedding. In particular, the target content item group generation system can analyze information about the content item to generate the content item embedding. For instance, in some embodiments, the target content item group generation system uses a large language model to analyze text corresponding to the content item, an entity associated with the content item, or other related text.

Furthermore, and as mentioned, the target content item group generation system can determine a similarity score between the content item embedding and the member embedding. The similarity score can indicate an alignment or match between a member's preferences and the characteristics of a given content item. For example, a high similarity score may suggest that the content item is likely to be of interest to the member based on the captured patterns, behaviors, and preferences represented in the member embeddings.

In some implementations, the target content item group generation system constructs a target content item group. In particular, the target content item group generation system can determine a threshold similarity score. The target content item group generation system can accordingly filter members based on their similarity scores with a given content item. By identifying members corresponding to similarity scores that satisfy a threshold similarity score, the target content item group generation system can generate a target content item group comprising members that have a common predicted interest in a given content item.

Some existing systems attempt to efficiently target users for marketing certain products or services. However, existing systems often face technical challenges in intelligently identifying target user groups. For example, existing systems are often inaccurate because they rely on limited user information to classify target user groups. Existing systems often use basic demographic data and past purchase history to segment users, which can lead to oversimplified and inaccurate classifications. Without considering more nuanced user data, existing systems often struggle to accurately predict user interests and needs. Furthermore, by constructing target user groups using limited information, existing systems may result in a limited number of broad target user groups that fail to capture diversity of user preferences. This oversimplification can lead to intensive competition within the broad target user groups, less personalization for users within the user groups, decreasing user engagement, and ultimately poor returns on investment (ROI).

In addition to problems with accuracy, existing systems are often inflexible and confined to a set number of predefined content item and product categories. More specifically, existing systems analyze traits of a set number of product categories or content item categories and determine whether users would be interested in the product categories or content item categories. This rigidity often limits the ability of publishers to tailor content item strategies to the diverse and evolving interests of potential users. For example, existing systems may restrict the targeting of relevant audiences for a wider range of content items. Accordingly, some existing systems continue to use pre-existing target user groups for new or expanded content items, which may result in poorly targeted content items.

Expanding the product categories within existing systems present significant challenges that further compound inefficiencies. To illustrate, adding new product categories can require substantial reconfiguration of the underlying classification algorithms, which can be both time-consuming and resource intensive. Existing system typically require manual adjustments and extensive testing to ensure that new categories are integrated seamlessly. Consequently, existing systems are often limited in adapting to emerging trends.

Furthermore, existing systems are often applied in business-to-consumer (B2C) settings where the existing system identifies content items in which a user may express individual interest. Existing systems can be significantly inaccurate when applied to members within a business-to-business (B2B) setting. More specifically, existing systems typically rely on analyzing individual user behavior, which is often driven by personal preferences, emotions, and relatively short sales cycles. In contrast, B2B interest decisions are more complex, involving multiple stakeholders, longer sales cycles (e.g., months, multiple quarters, etc.), and decisions based on various criteria such as cost-benefit analysis, strategic alignment with entity goals, and other criteria. Existing systems are often incapable of accurately predicting stake holding users in a target content item group that would influence the interest and decisions of an entity.

The target content item group generation system can improve accuracy, flexibility, and efficiency relative to existing systems. In contrast to existing systems that rely on limited user information to classify user groups, the target content item group generation system can generate a member embedding using features from various sources. More specifically, the target content item group generation system can generate a member embedding based on a member information embedding and a member activity embedding. Furthermore, the target content item group generation system collects additional information regarding content items by generating a content item embedding.

The target content item group generation system can also improve flexibility relative to existing systems. In contrast to existing systems that are inflexible and often confined to a set number of product categories, the target content item group generation system generates content item embeddings using a content item model. Thus, rather than being limited to a set number of product categories, the target content item group generation system can use the content item model to dynamically generate content item embeddings for any number of content items. The target content item group generation system can thus construct a target content item group that is individually tailored to any number of content items.

Furthermore, the target content item group generation system can improve efficiency relative to existing systems. The target content item group generation system can obviate the need for product categories by using the content item model to generate content item embeddings. More specifically, rather than relying on product categories to group users, the target content item group generation system can instead generate more granular content item embeddings. Thus, the target content item group generation system can reduce memory and compute resources required to analyze content items and pair content items to a target content item group.

Additionally, the target content item group generation system can more accurately predict a target content item group within a B2B setting. In particular, the target content item group generation system integrates multiple types of data embeddings including member outreach embeddings, member activity embeddings, and member information embeddings, to identify members that are stakeholders within an entity that can influence the entity's interest in a content item. By combining the diverse embeddings, the target content item group generation system can more accurately model relationships and decision-making processes typical of B2B environments, leading to more accurate target content item group predictions.

As illustrated by the foregoing discussion, the present disclosure utilizes a variety of terms to describe features and advantages of the activity difference system. Additional detail is now provided regarding the meaning of such terms. For example, as used herein, the term “member” refers to an individual who participates in an online platform. In particular, a member refers to an individual who has created an account and engages with an online platform's features and content. A member may contribute to an online platform by creating content, interacting with other users, and utilizing an online platform's services.

As used herein, the term “member information” refers to a digital representation of a member's information on a platform. A member information can store information associated with a member account on an online platform (e.g., a social media platform or a professional networking platform). For instance, a member information can include information associated with a user's identity, interests, activities, connections, or other information. In one example, a member information may comprise an online platform profile including professional history and skills. Member information can include text data.

As used herein, the term “member activity” refers to any interaction or engagement a member has with an online platform. In particular, a member activity includes actions such as posting updates, commenting on content, liking or sharing posts, and messaging other users. In some examples, member activity specifically encompasses interactions with content items, such as viewing, clicking, liking, sharing, or commenting on content items. A member activity can further comprise how a member interacts with content items with an objective of driving further engagement. For instance, member activities can include member interactions with interactive ads, quizzes or polls, completions of questionnaires, member conversions, or other interactions with content items meant to drive further engagement.

As used herein, the term “embedding” refers to a vector of numbers or features that represent data. In particular, an embedding can represent data such as words, images, activities, or other data in a low-dimensional vector space. For example, an embedding can be learned through neural network models, enabling a model to discern intricate patterns and similarities in data. For example, an embedding may comprise a member information embedding that represents member information data, a member activity embedding that represents member activity, a member embedding that represents a combination of a member information and member activity, or a content item embedding that represents content item data.

As used herein, the term “content item” refers to digital material that can be created, shared, and viewed via an online platform. In particular, a content item can include various forms such as text, images, videos, and interactive media designed to achieve specific objectives. More specifically, a content item may comprise an advertisement for a product or service. A content item may also comprise a series of digital media centered around a product or service. For example, a content item may comprise a digital campaign meant to achieve specific objectives such as brand awareness, lead generation, sales, or other objectives.

As used herein, the term “machine learning model” (or simply “model) refers to an algorithm that can be trained and/or tuned based on inputs to determine classifications, scores, or approximate unknown functions. In particular, a machine learning model includes a trained algorithm that can make predictions based on input data. More specifically, a machine learning model can implement deep learning techniques to model high-level abstractions in data. A machine learning model can include a neural network having various layers, including an input layer, one or more hidden layers, and an output layer that each perform tasks for processing data. For example, a machine learning model can include a large language model (LLM), a wide & deep model, a multilayer perceptron (MLP), or another type of model.

As used herein, the term “large language model” (or “LLM”) refers to a machine learning model trained to perform computer tasks to generate or identify content items in response to trigger events (e.g., user interactions, such as text queries, prompts, and button selections). In particular, a large language model can be a neural network with many parameters trained on large quantities of data (e.g., unlabeled text) using a particular learning technique (e.g., self-supervised learning). For example, a large language model can include parameters trained to generate or identify content items based on various contextual data, including graph information from a knowledge graph and/or historical user account behavior. Additionally, a large language model may comprise a generative pre-trained transformer (GPT) model. For instance, a large language model may comprise Open AI Text Davinci, CODIT-T5, UnixCoder and GraphCodeBert, or another type of large language model.

As used herein, the term “similarity score” refers to a value that quantifies the degree of similarity between two points. In particular, a similarity score refers to a numerical value that quantifies the similarity between a member embedding and a content item embedding. For example, a similarity score can be calculated using similarity metrics such as cosine similarity, Euclidean distance, dot product, or other methods. The similarity score reflects how closely related or similar two or more embeddings are in a high-dimensional vector space. Higher similarity scores indicate that the embeddings, and thus the data points that they represent, are more alike. Lower similarity scores signify greater dissimilarity between two or more embeddings.

Relatedly, the term “threshold similarity score” refers to a numerical value used as a cutoff point to determine whether a similarity score is high enough for a specific application or task. In particular, a threshold similarity score includes a value used to determine whether a member embedding is similar enough to a content item embedding to qualify a corresponding member to be in a target content item group. For example, if a similarity score between a content item embedding and a member embedding satisfies a threshold similarity score, the target content item group generation system can infer that the member is likely interested in the content item.

The term “target content item group” refers to a segment of members that share common characteristics, preferences, or behaviors. In particular, a target content item group comprises a targeted audience for a content item. By categorizing members into target content item groups, the target content item group generation system can deliver content items that meet the needs and interests of each target content item group.

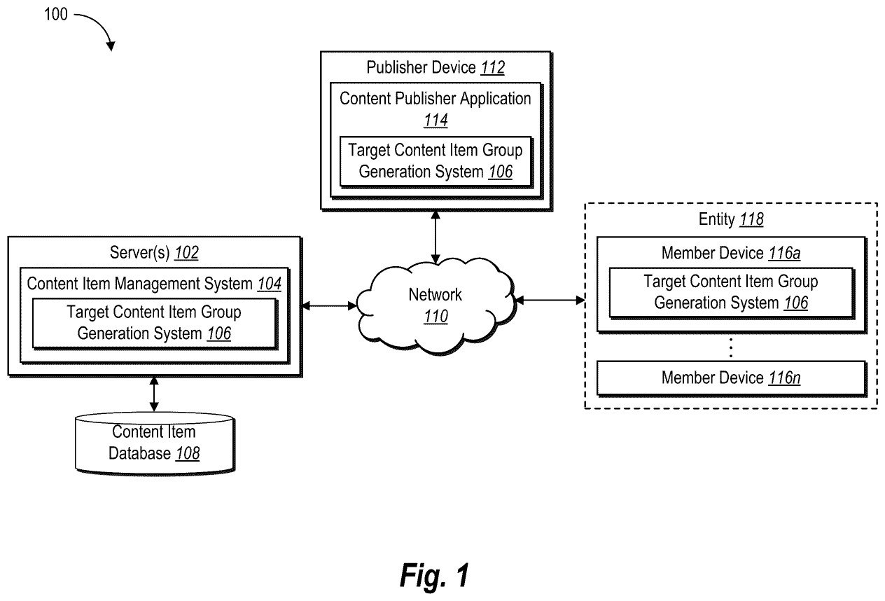

Additional detail regarding the target content item group generation system will now be provided with reference to the figures. For example, FIG. 1 illustrates a schematic diagram of an example system environment for implementing a target content item group generation system 106 in accordance with one or more embodiments. An overview of the target content item group generation system 106 is provided in relation to the subsequent figures.

Turning now to FIG. 1, this figure depicts a block diagram illustrating an environment 100 in which a target content item group generation system 106 can operate in accordance with one or more embodiments. As illustrated in FIG. 1, the environment 100 includes server(s) 102, a publisher device 112, member devices 116a-116n, and a network 110. The server(s) 102 host a content item management system 104, which includes the target content item group generation system 106.

In general, the content item management system 104 can generate, revise, manage, and execute digital content items. For instance, the content item management system 104 can generate (e.g., via user input from the publisher device 112) content item parameters, such as a target content item members (e.g., targeting characteristics), budget, timeline, channels, or other parameters. The content item management system 104 can also create or modify target content item groups (e.g., via the target content item group generation system 106), including creation of target content item groups and the addition or removal of members from the target content item groups.

Moreover, the content item management system 104 can distribute digital content via a variety of digital delivery channels to the member devices 116a-116n. For instance, the content item management system 104 can determine a similarity score between member embeddings corresponding with the client devices 116a-116n and content item embeddings. The content item management system 104 can distribute uniquely targeted content items to the member devices 116a-116n.

As shown in FIG. 1, the member devices 116a-116n may be associated with an entity 118. As used herein, the term “entity” refers to an organization of members. In particular, an entity comprises members that can be included in one or more target content item groups. For example, an entity may comprise a company in which members are employees, stakeholders, or associates. In some implementations, the target content item group generation system 106 determines that the entity 118 is treated as a single unit and belongs within one or more target content item groups. Furthermore, the member devices 116a-116n associated with the entity 118 can each belong to different target content item groups or the same target content item groups as each other.

Although FIG. 1 illustrates an arrangement of the server(s) 102, the publisher device 112, the client devices 116a-116n, and the network 110, various additional arrangements are possible. For example, the publisher device 112 and/or the client devices 116a-116n may directly communicate with the server(s) 102 and thereby bypass the network 110. Alternatively, in certain embodiments, the publisher device 112 includes all or a portion of the target content item group generation system 106. For explanatory purposes, however, this disclosure describes the server(s) 102 as including the target content item group generation system 106.

As further illustrated in FIG. 1, the publisher device 112 communicates through the network 110 with the target content item group generation system 106 via the server(s) 102. Accordingly, a publisher associated with the publisher device 112 can access one or more target content item group management features provided (in whole or in part) by the target content item group generation system 106, including to download a content publisher application 114. Additionally, in some embodiments, third party server(s) (not shown) provide data to the server(s) 102 that enable the target content item group generation system 106 to access, download, or upload content item information including documents, content-guideline-conforming documents, or audience-channel-specific documents via the server(s) 102.

As also shown in FIG. 1, in some embodiments, the target content item group generation system 106 accesses, manages, analyzes, and queries data corresponding to content items. For example, in some implementations, the target content item group generation system 106 accesses the content item database and analyzes content item information to generate content item embeddings. In some implementations, the target content item group generation system 106 receives content items from the publisher device 112 and stores the received content items in the content item database 108.

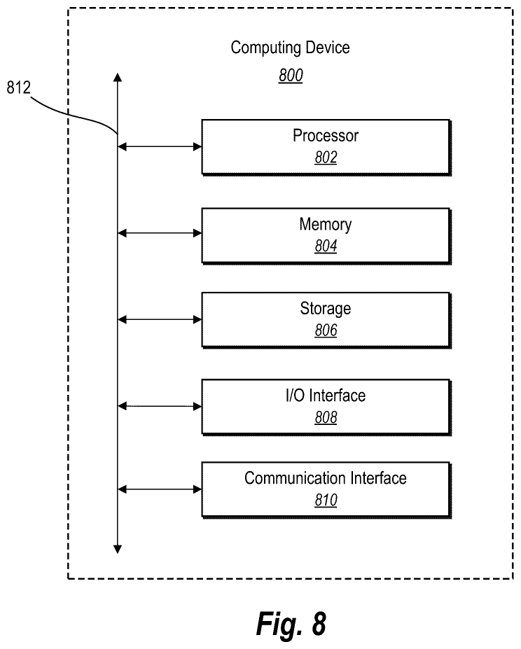

To access the target content item group generation system 106, in certain embodiments, a publisher interacts with the content publisher application 114 on the publisher device 112. In some embodiments, the content publisher application 114 comprises a web browser, applet, or other software application (e.g., native application) available to the publisher device 112. Additionally, in some instances, the content publisher application 114 is integrated within an application or webpage. While FIG. 1 illustrates one publisher device, in alternative embodiments, the environment 100 includes more than the publisher device 112 (and/or more than one user). Similarly, the environment 100 can include any number of member devices. For example, in other embodiments, the environment 100 includes hundreds, thousands, millions, or billions of users and corresponding publisher devices and/or members and corresponding member devices. The publisher device 112 and the member devices 114a-114n may include, but are not limited to, mobile devices (e.g., smartphones, tablets), laptops, desktops, or any other type of computing device, such as those described below in relation to FIG. 8.

Similarly, the network 110 may comprise any of the networks described below in relation to FIG. 8.

As further shown in FIG. 1, in certain implementations, the server(s) 102 perform various functions of the target content item group generation system 106. For example, in certain embodiments, the server(s) 102 receive user input indicating a content item from the publisher device 112. The server(s) 102 may further determine, from the member devices 116a-116n, a target content item group based on the content item.

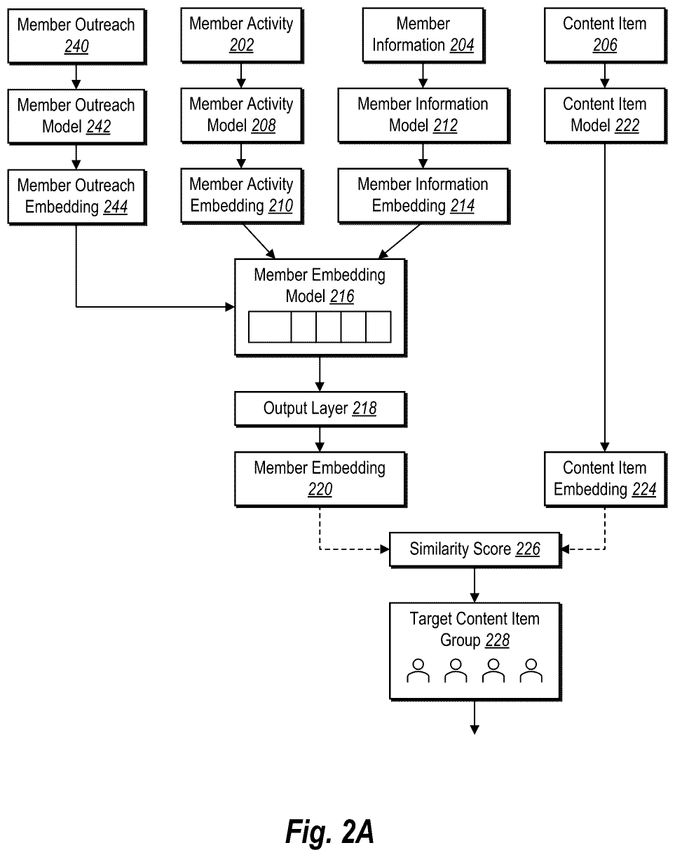

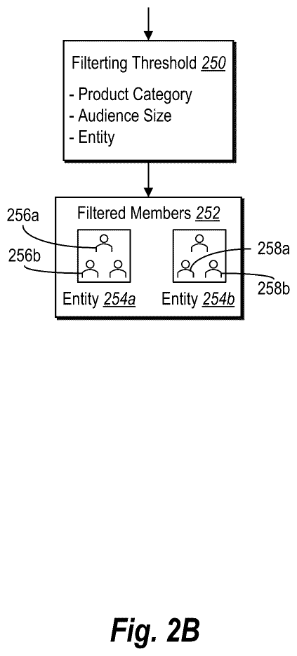

As mentioned, the target content item group generation system 106 can determine a target content item group. FIGS. 2A-2B illustrates the target content item group generation system 106 determining a target content item group in accordance with one or more embodiments. As shown in FIG. 2A, the target content item group generation system 106 can generate a target content item group comprising members that are likely interested and may influence outcomes in a content item. Furthermore, and as shown in FIG. 2B, the target content item group generation system 106 can identify filtered members and groups of filtered members within various entities.

As illustrated in FIG. 2A, in some embodiments, the target content item group generation system 106 uses an embedding-based-retrieval (EBR) model to score similarities between members and content items. The EBR model often employes a two-tower architecture comprising two separate neural networks (towers) that generate embeddings for the member and the content item independently. Each tower of the two-tower model is dedicated to a different type of feature data-(i) member data and (ii) content item data. The target content item group generation system 106 compares the embeddings using a similarity measure, such as a cosine similarity or dot product, to identify the most similar items. The two-tower model can enhance the EBR approach by allowing each tower to specialize processing its respective input, leading to more accurate and efficient retrieval.

The EBR approach can be more computationally efficient. For example, in some examples, the target content item group generation system 106 can execute the EBR model offline. Existing systems may train models on a set of existing content items. When new content items are added or existing content items are modified, existing systems often require retraining their models with the new or modified content items. In contrast, the target content item group generation system 106 can use the EBR to generate content item embeddings offline. When content items are added or modified, the target content item group generation system 106 can simply use the EBR model to generate new content item embeddings and compare the new content item embeddings with member embeddings instead of retraining a model from scratch.

FIG. 2A illustrates various neural networks including a member outreach model 242, a member activity model 208, a member information model 212, and a content item model 222. In some implementations, each of these models comprises a separate machine learning model. In other implementations, the target content item group generation system 106 can utilize a single machine learning model to generate two ore more of the member outreach embedding, the member activity embedding, the member information embedding, and the content item embedding. For instance, in some implementations, the target content item group generation system 106 uses a single LLM to generate both the member information embedding 214 and the content item embedding 224.

As shown in FIG. 2A, the target content item group generation system 106 uses a member outreach model 242 to generate a member outreach embedding 244 based on member outreach 240. Member outreach 240 comprises a feature on the (i) member data side. As used herein, the term “member outreach” refers to efforts by an entity or organization to engage with a member. In particular, member outreach comprises sales data or marketing data associated with the member. For example, member outreach can comprise data regarding an entity's efforts to engage with the member and also the member's responses to the engagement efforts. Member outreach can include data that includes member preferences, purchase history, engagement patterns, and other data.

As shown in FIG. 2A, the target content item group generation system 106 uses the member outreach model 242 to generate the member outreach embedding 244. The member outreach embedding 244 comprises a data representation used to encapsulate the member outreach 240. The member outreach embedding 244 integrates various dimensions of marketing data and sales data including engagement history, communication preferences, transaction records, behavioral patterns, and other data associated with the member.

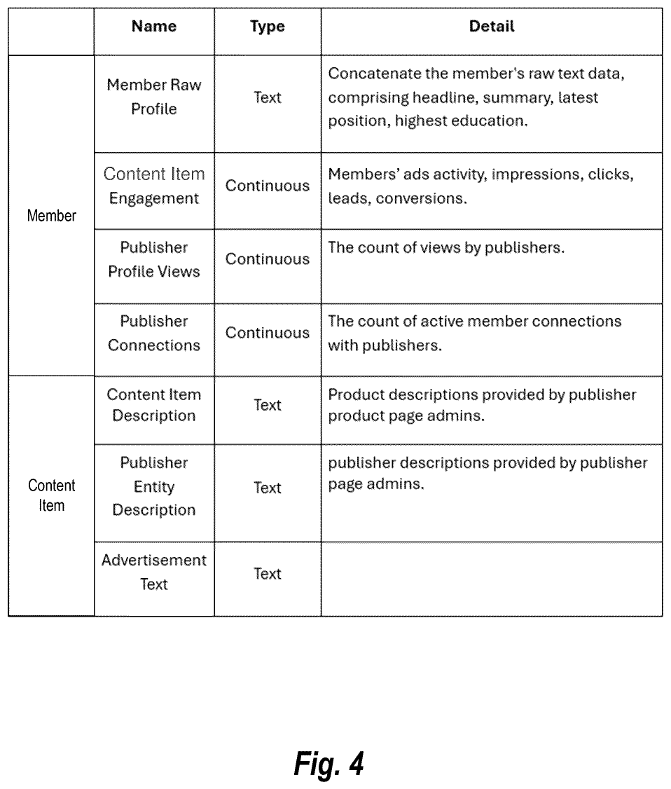

As shown in FIG. 2A, the target content item group generation system 106 uses a member activity model 208 to generate a member activity embedding 210 based on member activity 202. Member activity 202 comprises a feature on the (i) member data side. Member activity can include member activities initiated on a member device. Additionally, in some examples, member activity can comprise activities performed on a member profile by other members or publishers. FIG. 4 further details example member activity features in accordance with one or more embodiments.

As shown in FIG. 2A, the target content item group generation system 106 uses a member activity model 208 to transform the input member activity 202 data. The member activity model 208 comprises a neural network with layers that transform the member activity 202 data through weighted connections and non-linear activation functions. In some implementations, the member activity model 208 comprises a multilayer perceptron (MLP). For example, the member activity model 208 may comprise an input layer that receives the raw member activity 202 data, one or more hidden layers that process the member activity 202 data, and an output layer that produces the member activity embedding 210.

As mentioned, the member activity model 208 may comprise a MLP that can extract deep information from continuous features. Continuous features comprise types of variables in a dataset that can take on an infinite number of values within a given range. The member activity model 208 can comprise an MLP having multiple layers of neurons that perform non-linear transformations on input data. By feeding continuous features into the MLP's input layer and passing them through hidden layers, the MLP can learn to identify patterns and relationships in the member activity 202 data and generate embedding data that represents the continuous features in a meaningful way.

As shown in FIG. 2A, the target content item group generation system 106 generates the member activity embedding 210. The member activity embedding 210 comprises a dense vector representation that encapsulates interactions a member has with content items, publishers, and interactions that publishers have with the member via a member profile. The member activity embedding 210 can also represent member activities that a member has with content items meant to drive additional engagement.

As mentioned, the target content item group generation system 106 leverages different types of data for a member as part of generating a member embedding. As shown in FIG. 2A, in addition to analyzing the member activity 202, the target content item group generation system 106 also accesses data from the member information 204. In some embodiments, the member information 204 data comprise raw text data from the member profile. For example, the member information 204 may comprise all text associated with a member profile or any other data associated with a member. As described in greater detail below with respect to FIG. 4, the member information 204 may comprise raw text data input by the member as part of creating a member profile. Member information 204 can further comprise additional member information input by the member that is descriptive of the member.

The target content item group generation system 106 uses a member information model 212 to analyze the member information 204. The member information model 212 comprises a machine learning model designed to convert text data from the member information 204 to vector representations that capture the semantic meaning and relationships between words within the member information 204. For example, in some implementations, the member information model 212 comprises a large language model (LLM).

As shown in FIG. 2A, the target content item group generation system 106 uses the member information model 212 to generate the member information embedding 214. The member information embedding 214 comprises a dense vector representation that encapsulates text within the member information 204. The member information embedding 214 captures the semantic meaning and key attributes of text found in the member information 204, such as a headline, summary, position, highest education, and other member information 204 data.

As further illustrated in FIG. 2A, the target content item group generation system 106 can generate a member embedding 220 based on the member activity embedding 210, the member outreach embedding 244, and the member information embedding 214. In some implementations, the target content item group generation system 106 generates the member embedding 220 by concatenating the member activity embedding 210 and the member outreach embedding 244 with the member information embedding 214 and feeding this concatenated embedding into another neural network. Combining the member outreach embedding 244, the member activity embedding 210, and the member information embedding 214 allows for a richer, more comprehensive representation of each member, enabling the target content item group generation system 106 to more accurately predict target content item groups. With these embeddings, the target content item group generation system 106 combines aspects of a member's behaviors, interactions, characteristics, and preferences into a single, unified profile. The target content item group generation system 106 can compare the member embedding 220 with a content item embedding to predict a member's level of interest in a particular content item.

In some examples, the target content item group generation system 106 feeds the member activity embedding 210, the member outreach embedding 244, and the member information embedding 214 into the member embedding model 216. The member embedding model 216 may comprise a wide and deep model. The wide and deep model can comprise a hybrid machine learning architecture that combines the strengths of linear models (e.g., the wide component) and deep neural networks (e.g., the deep component) to enhance predictive performance and generalization. The wide and deep model thus combines the strengths of memorization and generalization. The wide and deep model takes into account all the levels from wide to deep every time it generates deeper information, resulting in the creation of cross-features among wide, everything in between, and deep.

The wide and deep components of the wide and deep model (i.e., the member embedding model 216) processes the member activity embedding 210, the member outreach embedding 244, and the member information embedding 214 and then feed the processed embeddings into the output layer 218. The output layer 218 comprises a final layer that combines the processed information from both the wide component and the deep component. The output layer 218 synthesizes the outputs from the components of a wide and deep model to generate a result that leverages both memorized feature interactions and learned representations.

As further shown in FIG. 2A, the target content item group generation system 106 generates the member embedding 220 based on the output layer 218. In some instances, the target content item group generation system 106 passes the output layer 218 through a fully connected neural network to generate the member embedding 220. More specifically, the target content item group generation system 106 trains and uses a fully connected neural network to take the final combined representation from the member embedding model 216 and refine it into a dense vector.

The target content item group generation system 106 thus generates the member embedding 220. As mentioned, the member embedding 220 encapsulates the member outreach embedding 244, the member activity embedding 210, and the member information embedding 214. In particular, the member embedding 220 comprises a comprehensive vector representation designed to integrate member behavioral data with member information. As mentioned, the member embedding 220 combines aspects of a member's historical interactions with content items, behaviors, and characteristics into a single, united profile. The member embedding 220 comprises a comprehensive representation of the member. The member embedding 220 captures interactions of the member, such as their clicks, views, and engagements with various content items as well as profile attributes like demographics, interests, skills, education, etc. The target content item group generation system 106 can use the member embedding 220 to predict whether a member will have an interest in a particular content item.

As illustrated in FIG. 2A, the target content item group generation system 106 also generates a content item embedding 224 by using a content item model 222 to analyze a content item 206. The content item 206 may comprise a campaign for a product or a product itself. In some implementations, the target content item group generation system 106 uses the content item model 222 to analyze information or data from the content item 206. For instance, in some implementations, the target content item group generation system 106 extracts text data from the content item 206. FIG. 4 and the corresponding paragraphs further detail examples of content item 206 data in accordance with one or more embodiments of the present disclosure.

As further illustrated in FIG. 2A, the target content item group generation system 106 may use the content item model 222 to generate the content item embedding 224. In some examples, the content item model 222 comprises a machine learning model designed to convert text data from the content item 206 to vector representations that capture the semantic meaning and relationships between words within the content item 206. For example, in some implementations, the content item model 222 comprises an LLM. In other examples, the content item 206 does not exclusively contain text. In such embodiments, the target content item group generation system 106 may use another type of machine learning model to generate the content item embedding. For instance, the target content item group generation system 106 may use an MLP to generate the content item embedding.

The content item embedding 224 illustrated in FIG. 2A comprises a dense vector representation that encapsulates text or other data within the content item 206. The content item embedding can capture the semantic meaning and key attributes of data found within the content item 206 including product description, entity description, and creative text within the content item 206.

As mentioned, in some implementations, the content item model 222 and the member information model 212 comprise LLMs. In some embodiments, the content item model 222 and the member information model 212 comprise the same LLM. LLMs provide a powerful method for representing text data through vectors that capture the semantic meaning of the text. In some examples, the target content item group generation system 106 effectively utilizes LLMs by fine-tuning pre-trained LLMs. To illustrate, the member information model 212 and/or the content item model 222 may comprise a pre-trained LLM that the target content item group generation system 106 has fine-tuned. For example, pre-trained LLMs may comprise Bidirectional Encoder Representations from Transformers (BERT). For instance, the target content item group generation system 106 may fine-tune the BERT model using text data from a platform. Fine-tuning pre-trained LLMs such as BERT offer several benefits. For example, fine-tuning allows the LLM to specialize for specific tasks or domains, enhancing its performance on targeted objectives. Additionally, by starting from a pretrained LLM, fine-tuning typically requires fewer training iterations to achieve good performance compared to training from scratch.

As further shown in FIG. 2A, the target content item group generation system 106 generates a similarity score 226 between the member embedding 220 and the content item embedding 224. In particular, the target content item group generation system 106 may normalize the member embedding 220 and the content item embedding 224. In some examples, the target content item group generation system 106 uses L2 normalization, also known as L2 norm or Euclidean norm normalization, to scale elements of the member embedding 220 and the content item embedding 224. By ensuring that the member embedding 220 and the content item embedding 224 have a consistent scale, the target content item group generation system 106 can improve the performance and stability of learning algorithms.

The target content item group generation system 106 calculates the similarity between the member embedding 220 and the content item embedding 224 to generate the similarity score 226. In some embodiments, the target content item group generation system 106 calculates a cosine similarity between the embedding data from the two towers: (1) the member embedding 220 and (2) the content item embedding 224. Cosine similarity measures the cosine of the angle between the two embeddings. The resulting similarity score 226 from a cosine similarity function ranges from −1 (completely dissimilar) to 1 (identical). In some implementations, instead of calculating a cosine similarity between the member embedding 220 and the content item embedding 224, the target content item group generation system 106 generates the similarity score 226 by using different metrics such as Euclidian distance, Manhattan distance, dot product, Jaccard similarity, Pearson correlation coefficient, Mahalanobis distance, and other metrics. In any case, the target content item group generation system 106 generates a numerical similarity score.

In some embodiments, the target content item group generation system 106 linearly scales the similarity score 226 to [0,1]. More specifically, the target content item group generation system 106 can transform the value of the similarity score 226 to fall within the range of 0 to 1. The target content item group generation system 106 can do so by adjusting the minimum and maximum to 0 and 1 respectively, where 1 represents a perfect similarity and 0 represents no similarity. For example, if the target content item group generation system 106 determines the similarity score 226 using cosine similarity, the target content item group generation system 106 linearly scales the similarity score 226 from [−1,1] to [0,1]. In some examples, the similarity score 226 is already scaled to [0,1] and the target content item group generation system 106 does not need to perform the additional step of transforming the similarity score 226 to scale to [0,1].

The target content item group generation system 106 generates a target content item group 228 by using a threshold similarity score. For example, based on comparing the member embedding 220 with the content item embedding 224, the target content item group generation system 106 can determine a likelihood that the member has an interest in the content item 206. More specifically, the target content item group generation system 106 determines whether the similarity score 226 satisfies the threshold similarity score. Based on determining that the similarity score 226 satisfies the threshold similarity score, the target content item group generation system 106 may include the member in the target content item group 228.

In some examples, the target content item group generation system 106 automatically determines a threshold similarity score. For instance, the target content item group generation system 106 can determine the threshold similarity score based on a number of members within a target content item group. To illustrate, the target content item group generation system 106 can lower the threshold similarity score to increase a number of members within the target content item group 228. Conversely, the target content item group generation system 106 can raise the threshold similarity score to decrease the number of members within the target content item group 228.

Additionally, in some implementations, the target content item group generation system 106 receives the threshold similarity score as publisher input. In some examples, a publisher may determine to more narrowly tailor the content item 206 for members who likely have greater interest in the content item 206. Accordingly, the target content item group generation system 106 may receive input from a publisher device to increase a threshold similarity score.

As mentioned, the target content item group generation system 106 can predict a target content item group in a B2B setting. More specifically, the target content item group generation system 106 can process members within the target content item group 228 to identify entities that, based on influence from members within the target content item group 228, would be interested in the content item 206. FIG. 2B illustrates the target content item group generation system 106 using a filtering threshold 250 to determine filtered members 252 in accordance with one or more implementations of the present disclosure.

As shown in FIG. 2B, the target content item group generation system 106 uses the filtering threshold 250 to evaluate members within the target content item group 228. As used herein, the term “filtering threshold” refers to a criterion used to determine which members to include within filtered members based on particular metrics. In particular, based on determining that a filtering threshold is satisfied, the target content item group generation system 106 can predict that a member belongs to a determined group of filtered members. For example, a filtering threshold can comprise values relating to an entity. To illustrate, the target content item group generation system 106 may determine to include members associated with the entity within the filtered members 252. The filtering threshold 250 can also comprise a particular set of member characteristics (e.g., professional position within an entity), and others.

As mentioned previously, the target content item group generation system 106 can predict members of a target content item group that influence the interests of an entity relative to a content item. As used herein, the term “filtered member” refers to a member that is associated with an entity and influences the entity's behaviors in a B2B setting. In particular, a filtered member comprises a stake holding member within an entity that is involved in some part of the entity's decisions. For example, a filtered member may comprise a member of an entity involved in the decision-making process by evaluating potential content items, negotiating contracts, ensuring content items align with the entity's goals and budget constraints. More specifically, a filtered member comprises a stake holding member of an entity who is also part of a target content item group. The target content item group generation system 106 can identify filtered members by processing members within a target content item group based on various criteria. For instance, the target content item group generation system 106 can filter members of the target content item group 228 based on product category, audience size, and other criteria. As shown in FIG. 2B, the target content item group generation system 106 determines that members 256a-256b within an entity 254a and members 258a-258b within an entity 254b are filtered members.

For example, and as shown in FIG. 2B, the target content item group generation system 106 can determine a filtering threshold 250. In some embodiments, the target content item group generation system 106 dynamically determines the filtering threshold 250 based on a product category. In some instances, the target content item group generation system 106 identifies the filtered members 252 based on entities that have little to no interest in a content item. Individual members of an entity may express individual interest in a particular product or content item even if the entity does not have a need for the product or interest in the content item. For example, an entity that has already purchased and implemented a communication software would have low intent for a content item related to different communication software. The target content item group generation system 106 may aggregate intent scores of individual members within an entity to determine an entity intent score as part of determining the filtered members 252. More specifically, based on determining that the entity intent score satisfies the filtering threshold, the target content item group generation system 106 can include members within the filtered members 252. For instance, the target content item group generation system 106 can determine that members 256a-256b within entity 254a and members 258a-258b within entity 254b are within the filtered members 252 based on determining that the entities 254a-254b have entity intent scores that satisfy the filtering threshold 250.

In some examples, and as part of determining the filtered members 252, the target content item group generation system 106 determines a category of the content item 206. For example, the category of the content item 206 may comprise a product category (e.g., electronics, clothing, home appliances, software, etc.). The target content item group generation system 106 trains and uses an intent model to generate an intent score predicting a level of intent that a member has in the category of the content item. The target content item group generation system 106 may use the level of intent for the member as part of generating an aggregated intent score based on intent scores from members of an entity. More specifically, the target content item group generation system 106 combines the level of intent for the member with levels of intent for remaining members within the same entity. In some examples, the target content item group generation system 106 averages intent scores for members within the entity. In some implementations, the intent score comprises the similarity score 226. Thus, the target content item group generation system 106 determines an aggregated intent score that captures the intent of all or a proportion of members within an entity.

The target content item group generation system 106 compares the aggregated intent score with an entity intent threshold score. Based on determining that the aggregated intent score satisfies the entity intent threshold score, the target content item group generation system 106 can include the entity as a filtered entity. The target content item group generation system 106 can include members within filtered entities as filtered members 252.

In some embodiments, the target content item group generation system 106 dynamically determines the filtering threshold 250 based an audience size or the number of filtered members 252. For instance, the target content item group generation system 106 can determine the filtering threshold 250 that maximizes precision while ensuring a suitable audience size. By expanding the audience size, the target content item group generation system 106 increases the number of members within the filtered members 252. However, increasing the audience size can correspond with decreasing precision or the accuracy of members included within the filtered members 252.

Additionally, and as shown, the target content item group generation system 106 can identify the filtered members 252 based on entity. For instance, in some implementations, a publisher may wish to target entities with a content item. Accordingly, the target content item group generation system 106 can filter members based on their associations with particular entities. For instance, if a publisher would like to publish a content item for the entity 254a, the target content item group generation system 106 can include the members 256a-256b within the filtered members 252 because they belong to the entity 254a.

As mentioned, the target content item group generation system 106 can dynamically determine the filtering threshold 250. In some implementations, the target content item group generation system 106 determines the filtering threshold 250 by setting the filtering threshold based on past performance with an aim to maximize precision and ensure a suitable audience size of filtered members. For example, the target content item group generation system 106 can determine a candidate filtering threshold. The target content item group generation system 106 evaluates a number of candidate filtered members resulting from the candidate filtering threshold. In some implementations, the target content item group generation system 106 determines whether the number of candidate filtered members meets a threshold number or proportion (e.g., 7%) of the content item group. The target content item group generation system 106 can further evaluate the candidate filtered members based on precision. For example, the target content item group generation system 106 can evaluate the ratio of true positive leads (or correctly identified leads) to the total number of leads within the target content item group. The target content item group generation system 106 can thus determine to use the candidate filtering threshold as the filtering threshold 250 or evaluate another candidate filtering threshold.

The target content item group generation system 106 can further generate filtered members based on member characteristics. In particular, the target content item group generation system 106 can generate the filtered members based on member information. In some examples, the target content item group generation system 106 identifies stakeholders within the entity 254a and the entity 254b based on the member's professional position, interests, educational level, and other data. For instance, the target content item group generation system 106 can identify members having particular positions within the entities that are likely to contribute to purchasing decisions for the entity.

The filtered members 252 may comprise a combination of members and entities, where the target content item group generation system 106 considers an entity as a unit within the filtered members 252. For example, a publisher may wish to advertise a product to a company. The target content item group generation system 106 can identify the filtered members 252 comprising stake holding members within entities that likely have an interest in the content item 206.

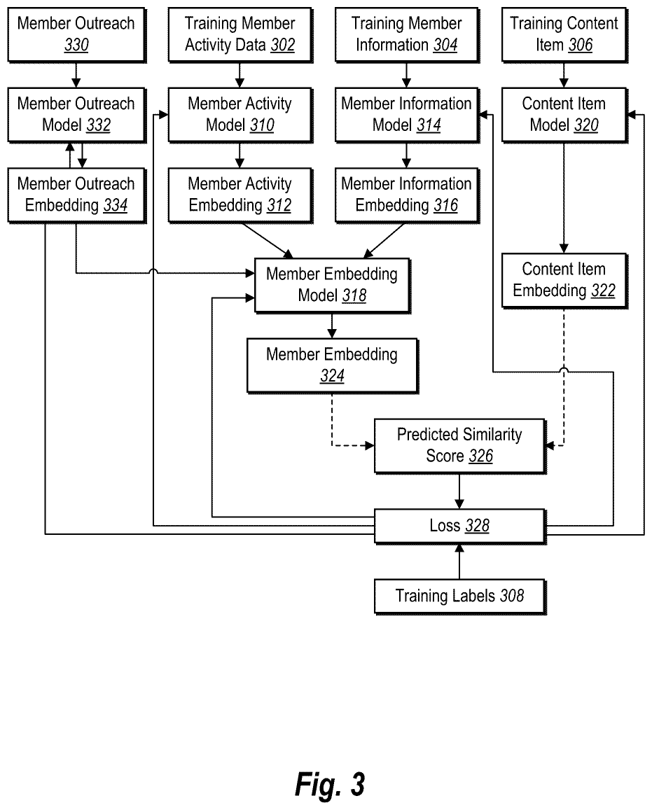

In some implementations, the target content item group generation system 106 can modify parameters of models within the two-tower model. FIG. 3 illustrates the target content item group generation system 106 modifying parameters of the member activity model, the member outreach model, the member information model, the content item model, and the member embedding model in accordance with one or more embodiments of the present disclosure.

As shown in FIG. 3, the target content item group generation system 106 modifies parameters of a member activity model 310, a member outreach model 332, a member information model 314, a content item model 320, and a member embedding model 318 using training data. In some implementations, two or more of the member outreach model 332, member activity model 310, member information model 314, and the content item model 320 comprise the same machine learning model. The training data comprises training member activity data 302, a training member information 304, a training content item 306, and training labels 308.

As shown in FIG. 3, the target content item group generation system 106 uses the training labels 308 to fine-tune the models. Generally, the training labels 308 comprises positive labels and negative labels assigned to members based on their interactions with the training content item 306. In particular, the target content item group generation system 106 assigns positive training labels to members based on particular objectives. The target content item group generation system 106 can achieve different objectives and fine-tunes the member activity model 310, the member outreach model 332, the member information model 314, the content item model 320, and the member embedding model 318 to meet certain objectives. The following table demonstrates example objectives set by the target content item group generation system 106 and training labels based on the objectives.

| Objective | Label Type | Member Description |
|---|---|---|
| Lead | Positive (1) | Members who submitted valid lead |
| generation | | generation |
| | Negative (0) | Members who clicked content items but did |
| | | not submit lead generation forms |
| Conversion | Positive (1) | Members who completed content item |
| | | conversions |
| | Negative (0) | Non-converting clickers of conversion |
| | | content items |
| Selection | Positive (1) | Members who selected a content item |
| | Negative (0) | Members who saw but did not select a |
| | | content item |

For the lead generation objective, the target content item group generation system 106 evaluates whether a training member successfully submits a valid lead generation. Generally, lead generation refers to the process of identifying and capturing potential members' interest in a product or service. This involves engaging members who have shown some level of interest or intent, often by interacting with a content item, such as clicking on a link, filling out a form, signing up for a newsletter, downloading a resource, etc. The target content item group generation system 106 labels training members as positive or negative based on whether the training members submitted valid lead generation (e.g., submitted a form, clicked a link, downloaded a resource, etc.) or not.

For the conversion objective, the target content item group generation system 106 evaluates whether a training member completed content item conversions or not. Generally, a conversion refers to the successful completion of a desired action by a member. Most commonly, a content item conversion comprises actions such as making a purchase, signing up for a subscription, requesting a quote, scheduling a consultation, etc. the target content item group generation system 106 labels training members as positive or negative in the conversion objective based on whether or not the training members completed content item conversions or not.

For the content item selection objective, the target content item group generation system 106 evaluates whether a training member selected a content item or not. In some examples, the content item comprises a digital ad. The target content item group generation system 106 evaluates whether training members selected the content item or not.

As mentioned, the target content item group generation system 106 can tune models based on various objectives. In some examples, the target content item group generation system 106 tunes the models based on the lead generation objective. Subsequently, the target content item group generation system 106 can fine-tune the models using conversions and content item selections. The target content item group generation system 106 may further tune the models using any order of objectives or with the use of additional objectives and labels.

As shown in FIG. 3, the target content item group generation system 106 uses a member activity model 310 to generate a member activity embedding 312 using training member activity data 302. The target content item group generation system 106 also uses a member information model 314 to generate a member information embedding 316 based on the training member information 304. The target content item group generation system 106 can also use the member outreach model 332 to generate a member outreach embedding 334 based on the training member outreach 330. As mentioned, the member outreach model 332, the member activity model 310, and/or the member information model 314 may comprise the same machine learning model. The target content item group generation system 106 further utilizes the member embedding model 318 to generate the member embedding 324 based on the member activity embedding 312, the member outreach model, and the member information embedding 316. The target content item group generation system 106 further utilizes the content item model 320 to generate a content item embedding 322 based on the training content item 306. The target content item group generation system 106 generates a predicted similarity score 326 based on comparing the member embedding 324 and the content item embedding 322.

As mentioned, in some embodiments, the target content item group generation system 106 linearly scales the predicted similarity score 326 to [0,1]. The target content item group generation system 106 can compare the predicted similarity score 326 with the training labels 308 to determine a loss 328. In some embodiments, the target content item group generation system 106 determines that positive labels equal 1 and negative labels equal 0. The target content item group generation system 106 modifies parameters of the models by backpropagating error, calculating the gradient of the loss function with respect to each weight in each of the models. The gradients indicate the direction and magnitude of weight adjustments needed to minimize the loss 328. The target content item group generation system 106 may further use an optimization algorithm to update the weights by subtracting a fraction of the gradient from the current weights. The target content item group generation system 106 may iteratively perform this process to progressively refine the weights of the member activity model 310, the member outreach model 332, the member information model 314, the content item model 320, and the member embedding model 318 to reduce the loss 328. As mentioned, the target content item group generation system 106 may perform successive iterations using different training labels associated with each objective.

In some examples, the target content item group generation system 106 determines the loss 328 by calculating a similarity between the predicted similarity score 326 and the training labels 308. For example, the target content item group generation system 106 can use a cosine function to compare the predicted similarity score 326 with the training labels 308. Thus, the loss 328 can comprise an entropy loss.

In some implementations, the target content item group generation system 106 updates each of the member activity model 310, the member outreach model 332, the member information model 314, the content item model 320, and the member embedding model 318 but at different learning rates. Because the target content item group generation system 106 uses pre-trained LLMs as the member information model 314 and the content item model 320, the target content item group generation system 106 may apply a smaller learning rate to the member information model 314 and the content item model 320.

As mentioned, the target content item group generation system 106 uses different feature data for the member and the content item to generate the member embedding and the content item embedding, respectively. FIG. 4 illustrates a table including details for example feature data for the member and content items that the target content item group generation system 106 uses to generate the member embedding and the content item embedding in accordance with one or more embodiments.

FIG. 4 illustrates feature data associated with a member. As mentioned, the target content item group generation system 106 can use an LLM to generate a member information embedding based on raw text data from a member information. As shown, the target content item group generation system 106 can extract member raw profile feature data. More specifically, the target content item group generation system 106 can extract text from the member information comprising a headline, summary, latest position, and highest education. The target content item group generation system 106 can extract additional text data including interests, descriptions, geographic location, member posts, messages, and any other raw text data from a member information.

Additionally, and as mentioned previously, the target content item group generation system 106 generates a member activity embedding based on member activity feature data. Member activity data generally comprises activities performed by the member or activities performed on the member profile. For example, member activity data can comprise content item engagement, publisher profile views, and publisher connections. Content item engagement comprises interactions by the member with various content items. Content item engagement can include members' ads activities such as impressions, clicks, leads, and conversions. Impressions are a metric used to measure the number of times a content item (e.g., an ad) is displayed on a member's screen. Clicks represent a number of times a member selects a content item.

As further illustrated in FIG. 4, member activity feature data further comprises publisher profile views. In particular, publisher profile views comprise a count of member information views by publishers. The publisher profile views can comprise a count of views by a publisher of a given content item or publishers of any content item.

Member activity feature data can further comprise publisher connections. More specifically, publisher connections represent a count of active member connections with publishers. For example, publisher connections can refer to a number of active member connections with a publisher of a given content item or publishers of any content item.

FIG. 4 further illustrates content item feature data. As mentioned, in some implementations, the target content item group generation system 106 uses an LLM to generate a content item embedding. As shown in FIG. 4, in some embodiments, the content item feature data comprises raw text data. For example, content item feature data can comprise at least one of a content item description, a publisher entity description, or advertisement text. Content item description can comprise a description of a content item or a product. More specifically, the content item description may comprise text describing the purpose of a product or service.

As further illustrated in FIG. 4, the content item feature data can include a publisher entity description. More specifically, the publisher entity description comprises a description of the publisher associated with the content item. A publisher entity description can comprise a company description, a company name, and other information about the publisher, such as location, the publisher's vision statement, a history of the publisher, and other information.

The content item feature data can further include advertisement text. For example, advertisement text can include creative language used to attract attention, convey a message, and prompt a specific action. Advertisement text can be from an individual advertisement that is part of or an entire content item. Advertisement text can also be from advertisements or content items for a specific publisher. For instance, advertisement text may be from advertisements for different products but from the same publisher.

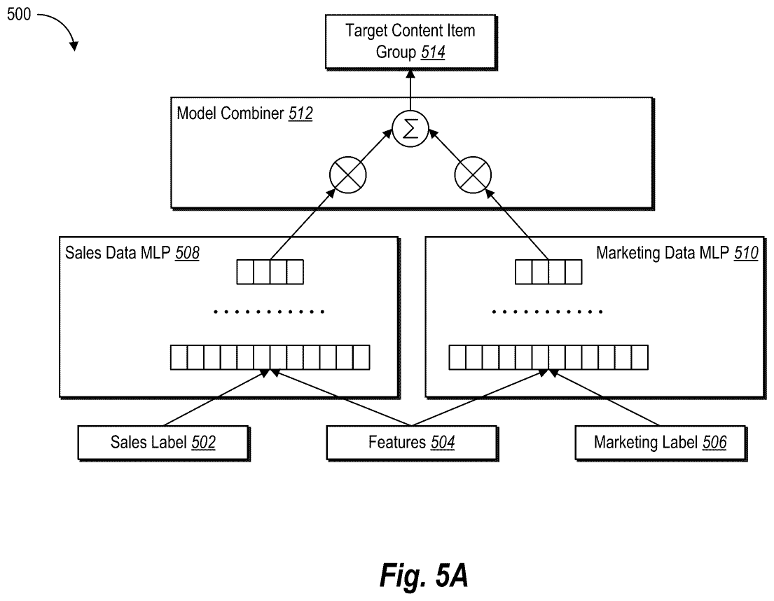

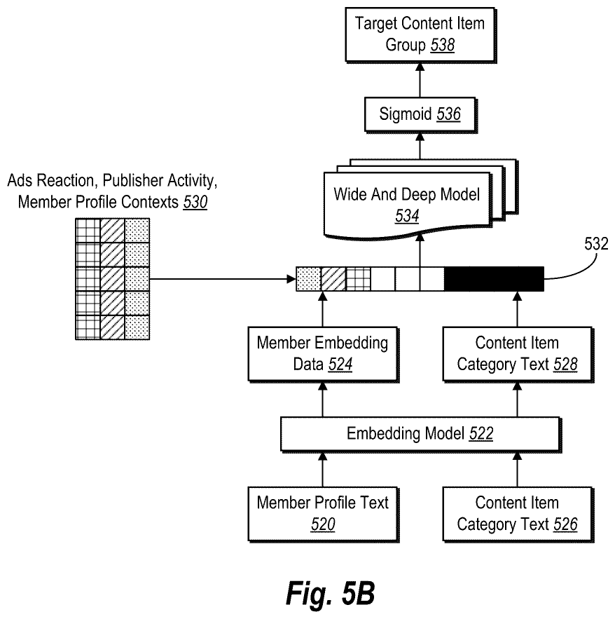

In some implementations, the target content item group generation system 106 utilizes alternative model architectures to the two-tower model illustrated in FIG. 2A-FIG. 3 to generate a target content item group. FIGS. 5A-5B illustrate an alternative classification model that generates a target content item group based on sales data and marketing data in accordance with one or more embodiments of the present disclosure.

FIG. 5A illustrates the target content item group generation system 106 training a sales data MLP 508 and a marketing data MLP 510 in a dual-pathway architecture 500 to predict a target content item group 514. Outputs of the sales data MLP 508 and the marketing data MLP 510 are combined using the model combiner 512 to generate the target content item group 514. The target content item group generation system 106 can use the dual-pathway architecture 500 to generate a target content item group 514 for a set number of product categories. This contrasts with the EBR model trained and utilized in FIG. 2A-FIG. 3 that does not rely on specific product categories.

As part of training the sales data MLP, the target content item group generation system 106 inputs a training sales label 502 into the sales data MLP 508. As illustrated in FIG. 5A, the sales data MLP 508 receives the sales label 502 and process the sales label 502 through its layers. The sales data MLP 508 focuses on extracting relevant features from the sales label 502 and features 504 to contribute to the final prediction. The sales data MLP 508 outputs a set of learned features that capture the underlying patterns and relationships within the sales label 502.

In some implementations, the target content item group generation system 106 generates the sales label 502 based on past sales data. For example, in some implementations, the sales label 502 comprises a positive “messages sent” label for members who received the most (e.g., top 1%) number of outreaches from publishers, per category. Additionally, the sales label 502 can comprise a positive “lead saved” label for members who were saved as a lead the most (e.g., top 1%) by publishers per category.

The target content item group generation system 106 can further input additional features 504 into the sales data MLP 508. For example, additional features may include the number and ratio of member views from related sales persons per category, number and ratio of connections from related sales persons per category, and number and ratio of messages from related sales persons per category.

Similarly, the marketing data MLP 510 processes the features 504 and marketing label 506 to extract meaningful representations of the marketing label 506 data to improve the overall performance of the marketing data MLP 510. The target content item group generation system 106 can generate the marketing label 506 based on past marketing data. For instance, the marketing label 506 can comprise a positive “top target” label for members who were targeted as an audience the most (e.g., top 0.01%) in the most popular or highly targeted frequency (e.g., 10% segments) per category.

Additionally, and as shown in FIG. 5A, the target content item group generation system 106 inputs additional features 504 into the marketing data MLP 510. For example, the target content item group generation system 106 can input features such as the number and ratio of related conversions per category, number and ratio of related selections or clicks per category, and the number and ratio of related impressions per category.

During training, and as illustrated in FIG. 5A, the target content item group generation system 106 generates the target content item group 514. The target content item group generation system 106 can compare the target content item group 514 with the sales label 502 and the marketing label 506 to generate a loss. The target content item group generation system 106 trains the sales data MLP 508 and the marketing data MLP 510 using backpropagation.

FIG. 5B illustrates an example MLP architecture for the sales data MLP 508 and the marketing data MLP 510. More specifically, the target content item group generation system 106 can use the MLP illustrated in FIG. 5B as the sales data MLP. The target content item group generation system 106 can use a separate MLP as the marketing data MLP. More specifically, the target content item group generation system 106 inputs different feature data into each of the MLPs—sales feature data and marketing feature data.

As shown in FIG. 5B, the target content item group generation system 106 inputs member information text 520 into an LLM (e.g., an embedding model 522) to generate member embedding data 524. In some examples, the embedding model 522 comprises a BERT embedding model. The target content item group generation system 106 further inputs content item category text 526 into the LLM (e.g., the embedding model 522) to generate content item embedding data 528. The target content item group generation system 106 performs feature concatenation 532 on the member embedding data 524, the content item embedding data 528, and additional features 530. The additional features 530 can include ads reactions, publisher activity, member information contexts, and other types of features.

The target content item group generation system 106 inputs the concatenated features into a wide and deep model 534. The target content item group generation system 106 uses the wide and deep model 534 to generate a sigmoid 536. The sigmoid 536 refers to the final output layer that uses the sigmoid activation function to produce a prediction. The sigmoid function can output a probability value between 0 and 1, indicating the likelihood that a given member belongs to a positive class (e.g., the target content item group 538). For example, the sigmoid 536 may comprise a similarity score between the member embedding data 524 and the content item embedding data 528. Based on the similarity score satisfying a threshold similarity score, the target content item group generation system 106 can include a member in the target content item group 538.

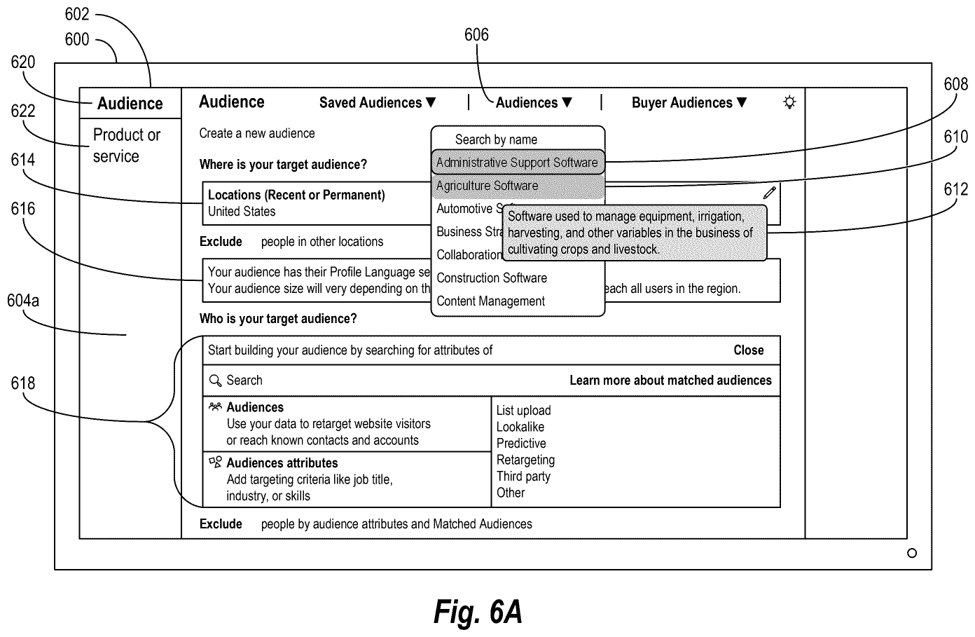

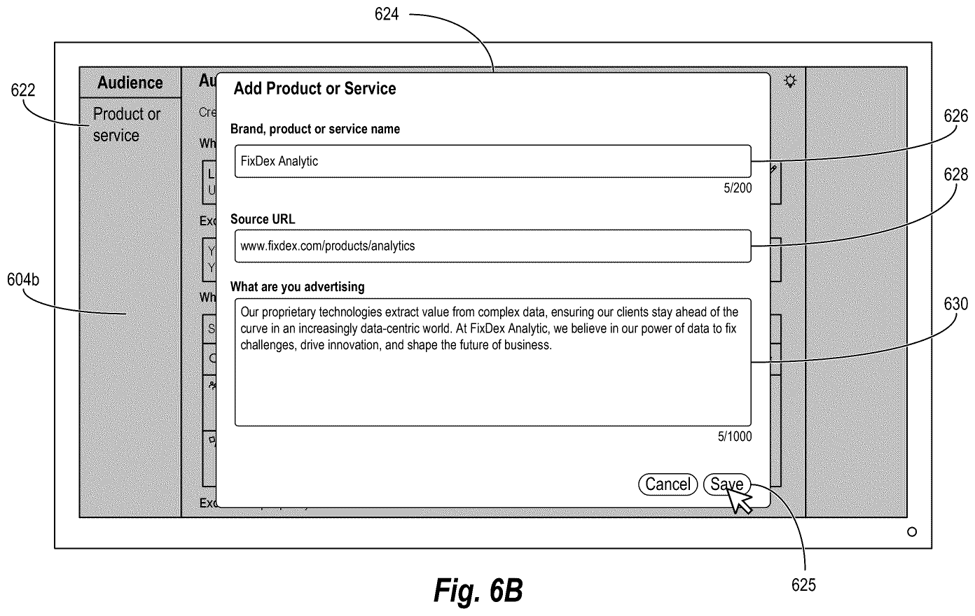

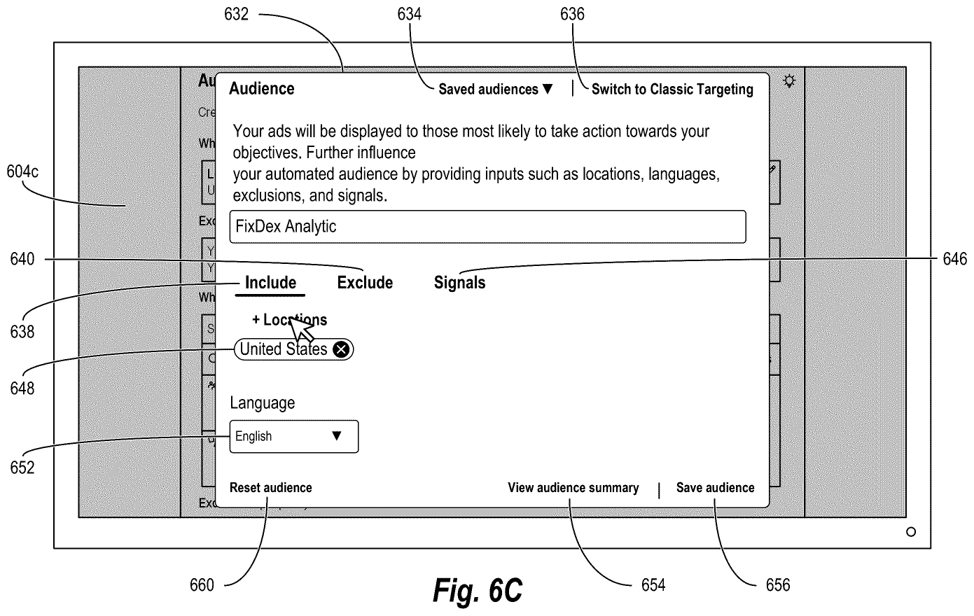

In some embodiments, the target content item group generation system 106 provides, for display via a publisher device, a content item management user interface for managing content items and target content item groups. FIGS. 6A-6C illustrate a series of example content item management user interfaces for managing content items and target content item groups in accordance with one or more embodiments.

FIG. 6A illustrates a content item management user interface 604a displayed on a screen 602 of a device 600 (e.g., a publisher device). The content item management user interface 604a includes an audience element 620 and a product or service element 622. Based on publisher selection of the audience element 620, the target content item group generation system 106 provides, for display via the content item management user interface 604a, options to customize and manage a target content item group (i.e., an audience). Based on detecting selection of the product or service element 622, the target content item group generation system 106 updates the content item management user interface 604a to provide options to customize and manage the content item.

As shown in FIG. 6A, the content item management user interface 604a includes various user interface elements to customize and manage a target content item group. The content item management user interface 604a includes a content item taxonomy element 606. In some examples, the content item taxonomy element 606 exposes potential target content item group taxonomies based on content item embeddings. In some examples, the content item taxonomy element 606 lists predetermined categories. Based on selection of the content item taxonomy element 606, the target content item group generation system 106 displays a category 608 and, in some implementations, one or more subcategories 610. The target content item group generation system 106 may further provide for display a category or sub-category description 612 that provides additional details regarding a selected category or sub-category. In some implementations, the category 608 and the one or more subcategories 610 comprise target content item groups that the target content item group generation system 106 has previously identified. In some examples, the target content item group generation system 106 can use pre-identified target content item groups and modify the pre-identified target content item groups based on content item embeddings and member embeddings.

The content item management user interface 604a illustrated in FIG. 6A comprises additional elements for customizing a target content item group. In particular, the content item management user interface 604a comprises a location selection element 614, an exclusion element 616, and target content item group trait selection elements 618. Based on publisher interaction with the location selection element 614, the target content item group generation system 106 can select members for a target content item group based on the geographical location of the members. Based on publisher interaction with the exclusion element 616, the target content item group generation system 106 can exclude particular members or entities from a target content item group. Based on publisher interaction with the target content item group trait selection elements 618, the target content item group generation system 106 selects for traits within a target content item group.

In some implementations, the target content item group generation system 106 generates a publisher-defined filter based on publisher interactions received via the content item management user interface 604a. For example, in some implementations, the target content item group generation system 106 utilizes the EBR model to generate a target content item group. The target content item group generation system 106 receives publisher interactions with the location selection element 614, the exclusion element 616, and/or the target content item group trait selection elements 618 to generate a group of filtered members from the target content item group.

Based on publisher selection of the product or service element 622, the target content item group generation system 106 updates the content item management user interface 604a to display user interface elements for receiving content item information. FIG. 6B illustrates a content item management user interface 604b including a content item information window 624. The content item information window includes various user interface elements by which the target content item group generation system 106 can receive content item information. As mentioned previously, the target content item group generation system 106 can receive text information describing a content item by which the target content item group generation system 106 can use to generate a content item embedding.

As shown in FIG. 6B, the content item information window 624 includes a content item name element 626, a source URL element 628, and a content item description element 630. A publisher may input, into the content item name element 626, the name of a brand, product, or service of a content item. Furthermore, the content item name element 626 can also receive a name of a campaign. The target content item group generation system 106 can receive, based on publisher interaction with the source URL element 628, a source URL corresponding with the content item. For example, a source URL may comprise a link to a webpage or website corresponding with a product or service corresponding with the content item. Furthermore, based on publisher interaction with the content item description element 630, the target content item group generation system 106 can receive a description of a content item. More specifically, a publisher may input into the content item description element 630 a description of a product or service being advertised using a content item. A publisher may also input into the content item description element 630 a description of a campaign or advertisement.

As shown in FIG. 6B, the target content item group generation system 106 may receive user selection of a save element 625. Based on receiving an indication of user selection of the save element 625, the target content item group generation system 106 can provide additional target content item group customization elements for customizing a target content item group for the described content item. FIG. 6C illustrates a content item management user interface 604c including a target content item group customization window 632.

As shown in FIG. 6C, the target content item group customization window 632 includes a saved target content item group element 634. Based on publisher interaction with the saved target content item group element 634, the target content item group generation system 106 can present previously utilized target content item groups. For example, a publisher may opt to utilize a previously used target content item group. The target content item group customization window 632 further includes a classic targeting element 636. For instance, a publisher may want to use classic targeting and not targeting using an EBR-model selected target content item group. Based on detecting user selection of the classic targeting element 636, the target content item group generation system 106 can use an existing buyer group system to identify a target content item group.

The target content item group customization window 632 illustrated in FIG. 6C further includes an include element 638, an exclude element 640, and a signals element 646. Based on selection of the include element 638, the target content item group generation system 106 provides options and values for potential members to be included within a target content item group. For instance, the target content item group generation system 106 may provide, via the content item management user interface 604c options to include members based on geographic location, language, and other features. To illustrate, the target content item group customization window 632 includes a location modification element and a selected location 648. The target content item group customization window 632 further includes a language selection element 652 for indicating a desired primary language for members within the target content item group.

The target content item group customization window 632 further includes a reset audience element 660 for removing all filters from the target content item group. The target content item group customization window 632 illustrated in FIG. 6C also includes a view audience summary element 654 and a save audience element 656. Based on publisher interaction with the view audience summary element 654, the target content item group generation system 106 provides, for display on the publisher device, a summary of the target content item group. For example, the summary of the target content item group can include information including publisher-selected filters, a number of members within the target content item group, similarities between members, and other relevant information. Based on receiving a selection of the save audience element 656, the target content item group generation system 106 can save filters and other publisher preferences for the target content item group.

As illustrated in FIG. 6C, based on receiving a selection of the exclude element 640, the target content item group generation system 106 provides options and values for excluding or filtering members from a target content item group. For instance, the target content item group generation system 106 can provide elements for excluding members from a target content item group based on location, language, association with particular entities, inclusion in previous target item groups, or other metrics. Exclusions can also include members within a publisher's or entity's contact list, or members associated with a particular entity.

As illustrated in FIG. 6C, the target content item group generation system 106 also provides, via the target content item group customization window 632, the signals element 646. The signals element 646 can indicate signals or features associated with a member. For example, the target content item group generation system 106 can determine to include or exclude members from a target content item group based on other features including interests, education, title, and other features associated with a member information.

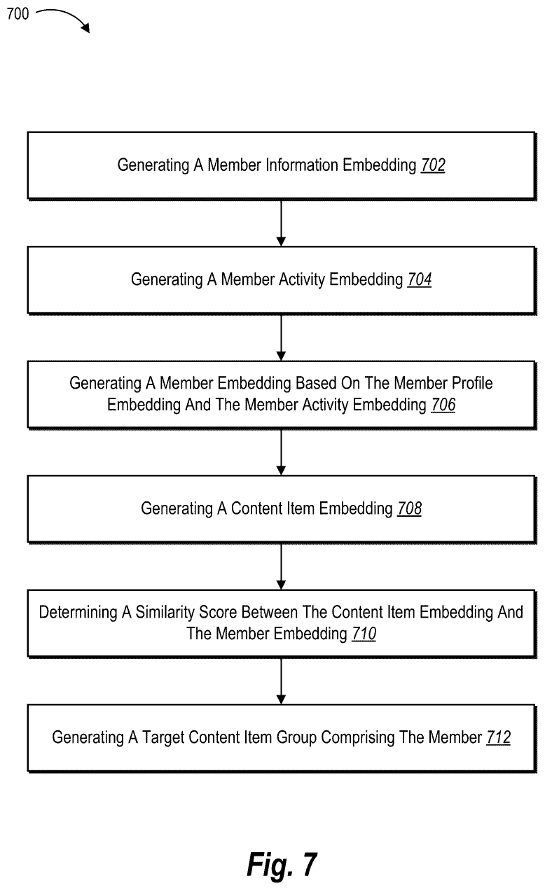

FIGS. 1-6C, the corresponding text, and the examples provide a number of different systems, methods, and non-transitory computer readable media for generating a target content item group in accordance with one or more embodiments. In addition to the foregoing, embodiments, can also be described in terms of flowcharts comprising acts for accomplishing a particular result. For example, FIG. 7 illustrates a flowchart of example sequences of acts in accordance with one or more embodiments.

While FIG. 7 illustrates acts according to some embodiments, alternative embodiments, may omit, add to, reorder, and/or modify any of the acts shown in FIG. 7. The acts of FIG. 7 can be performed as part of a method. Alternatively, a non-transitory computer readable medium can comprise instructions, that when executed by one or more processors, cause a computing device to perform the acts of FIG. 7. In still further embodiments, a system can perform the acts of FIG. 7. Additionally, the acts described herein may be repeated or performed in parallel with one another or in parallel with different instances of the same or other similar acts.

FIG. 7 illustrates a series of acts 700 for generating a target content item group using an EBR-model. The series of acts 700 includes an act 702 of generating a member information embedding, an act 704 of generating a member activity embedding, an act 706 of generating a member embedding based on the member information embedding and the member activity embedding, an act 708 of generating a content item embedding, an act 710 of determining a similarity score between the content item embedding and the member embedding, and an act 712 of generating a target content item group comprising the member.

In particular, the act 702 comprises generating a member information embedding reflecting member information associated with a member. The act 704 comprises generating a member activity embedding reflecting member activity data associated with the member. The act 706 comprises generating a member embedding based on the member information embedding and the member activity embedding. The act 708 comprises generating a content item embedding, reflecting information about a content item. The act 710 comprises determining a similarity score indicating a similarity between the content item embedding and the member embedding. The act 712 comprises generating a target content item group corresponding to the content item comprising the member based on determining that the similarity score satisfies a threshold similarity score.

In some embodiments, the series of acts 700 further comprises generating the member information embedding by using a large language model to analyze raw text data from the member information, wherein the member information model comprises the large language model; and generating the content item embedding by using the large language model to analyze raw text data reflecting information about the content item.

In some implementations, the series of acts 700 further comprises generating the member embedding by: generating a member outreach embedding reflecting outreach data associated with the member; and generating the member embedding based on the member information embedding, the member activity embedding, and the member outreach embedding.

In some implementations, the series of acts 700 further comprises generating the member activity embedding by using a multilayer perceptron to analyze member activity data corresponding with the member.

In some embodiments, the member activity data comprises at least one of content item engagement, publisher profile views, and publisher connections.

In some embodiments, the series of acts 700 further comprises generating the content item embedding by using a large language model to analyze raw text data reflecting information about the content item.

In some embodiments, the raw text data reflecting information about the content item comprises at least one of a content item description, a publisher entity description, or advertisement text.

In some embodiments, the series of acts 700 comprises additional acts of generate the member embedding by: using a wide and deep model to generate an output layer capturing interactions between the member information embedding and the member activity embedding, wherein the member embedding model comprises the wide and deep model; and generating the member embedding based on the output layer by extracting a dense vector representation from the output layer.

In some embodiments, the series of acts 700 further comprises providing, for display via a content item management user interface of a publisher device, the target content item group comprising the member.

In some embodiments, the series of acts 700 comprises providing, for display via a content item management user interface of a publisher device, filtered members corresponding to the target content item by: determining a category of the content item; generating, using an intent model, an intent score predicting a level of intent that the member has in the category of the content item; generating an aggregated intent score based on intent scores from members of an entity, wherein the intent scores comprises the intent score and the entity comprises the member; determining that an aggregated intent score corresponding to the entity satisfies an entity intent threshold score; and providing, for display via the content item management user interface, a member within the entity as a filtered member.

The components of the target content item group generation system 106 can include software, hardware, or both. For example, the components of the target content item group generation system 106 can include one or more instructions stored on a computer-readable storage medium and executable by processors of one or more computing devices. When executed by one or more processors, the computer-executable instructions of the target content item group generation system 106 can cause a computing device to perform the methods described herein. Alternatively, the components of the target content item group generation system 106 can comprise hardware, such as a special purpose processing device to perform a certain function or group of functions. Additionally, or alternatively, the components of the target content item group generation system 106 can include a combination of computer-executable instructions and hardware.

Furthermore, the components of the target content item group generation system 106 performing the functions described herein may, for example, be implemented as part of a stand-alone application, as a module of an application, as a plug-in for applications including content management applications, as a library function or functions that may be called by other applications, and/or as a cloud-computing model. Thus, the components of the target content item group generation system 106 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of exemplary computing device 800 (e.g., the server(s) 102 and/or the content item database 108) that may be configured to perform one or more of the processes described above. One will appreciate that server(s) 102, the publisher device 112, and/or the member devices 116a-116n may comprise one or more computing devices such as computing device 800. As shown by FIG. 8, computing device 800 can comprise processor 802, memory 804, storage device 806, I/O interface 808, and communication interface 810, which may be communicatively coupled by way of communication infrastructure 812. While an exemplary computing device 800 is shown in FIG. 8, the components illustrated in FIG. 8 are not intended to be limiting. Additional or alternative components may be used in other implementations. Furthermore, in certain implementations, computing device 800 can include fewer components than those shown in FIG. 8. Components of computing device 800 shown in FIG. 8 will now be described in additional detail.

In particular implementations, processor 802 includes hardware for executing instructions, such as those making up a computer program. As an example and not by way of limitation, to execute instructions, processor 802 may retrieve (or fetch) the instructions from an internal register, an internal cache, memory 804, or storage device 806 and decode and execute them. In particular implementations, processor 802 may include one or more internal caches for data, instructions, or addresses. As an example and not by way of limitation, processor 802 may include one or more instruction caches, one or more data caches, and one or more translation lookaside buffers (TLBs). Instructions in the instruction caches may be copies of instructions in memory 804 or storage device 806.

Memory 804 may be used for storing data, metadata, and programs for execution by the processor(s). Memory 804 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 804 may be internal or distributed memory.

Storage device 806 includes storage for storing data or instructions. As an example and not by way of limitation, storage device 806 can comprise a non-transitory storage medium described above. Storage device 806 may include a hard disk drive (HDD), a floppy disk drive, flash memory, an optical disc, a magneto-optical disc, magnetic tape, or a Universal Serial Bus (USB) drive or a combination of two or more of these. Storage device 806 may include removable or non-removable (or fixed) media, where appropriate. Storage device 806 may be internal or external to computing device 800. In particular implementations, storage device 806 is non-volatile, solid-state memory. In other implementations, Storage device 806 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 808 allows a user to provide input to, receive output from, and otherwise transfer data to and receive data from computing device 800. I/O interface 808 may include a mouse, a keypad or a keyboard, a touch screen, a camera, an optical scanner, network interface, modem, other known I/O devices or a combination of such I/O interfaces. I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 808 is configured to provide graphical data to a display for presentation to a user. The graphical data may be representative of one or more graphical user interfaces and/or any other graphical content as may serve a particular implementation.

Communication interface 810 can include hardware, software, or both. In any event, communication interface 810 can provide one or more interfaces for communication (such as, for example, packet-based communication) between computing device 800 and one or more other computing devices or networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 810 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 810 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 810 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 812 may include hardware, software, or both that couples components of computing device 800 to each other. As an example and not by way of limitation, communication infrastructure 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

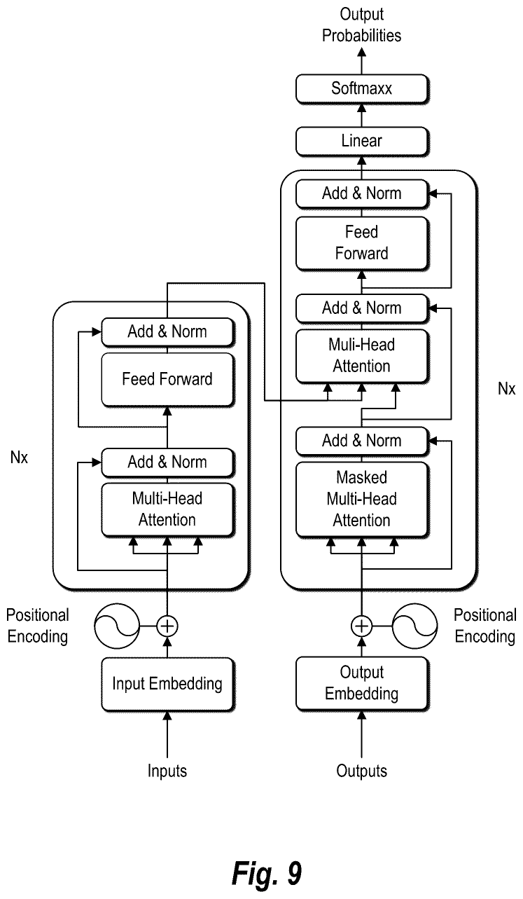

As mentioned, the target content item group generation system 106 can use a language learning model to member embeddings and content item embeddings based on text data from member informations and content items, respectively. FIG. 9 illustrates an example large language model in accordance with one or more embodiments of the present disclosure. Large Language Models (LLMs) work by employing various neural network components and techniques to process and generate text. FIG. 9 illustrates various components of an example LLM. In particular, the LLM illustrated in FIG. 9 may be hosted, all or in part, on a storage of a client device (e.g., the publisher device 112), a third-party server, and/or on a server device (e.g., the server(s) 102).

As shown in FIG. 9, an LLM can take raw text inputs, typically represented as sequences of tokens such as words or characters. These inputs could be anything from a single sentence to a lengthy document. For example, an input may include code.

Before processing the input sequence, the LLM transforms each token into dense numerical vectors called input embeddings. These embeddings capture semantic information about the tokens and help the LLM understand the meaning of the input.

Because LLMs process sequences of tokens, LLMs need to understand the order of these tokens. Positional encodings are added to the input embeddings to provide information about the position of each token in the sequence. This helps the model learn the sequential structure of the input.

As further shown in FIG. 9, the LLM can comprise a multi-head attention layer. Attention mechanisms are crucial for LLMs to focus on different parts of the input sequence when making predictions or generating text. Multi-head attention layers enhance this capability by using multiple sets of attention weights, allowing the model to attend to different aspects of the input simultaneously.

As illustrated in FIG. 9, the LLM may include add & norm layers. In this step, residual connections are added to the outputs of the multi-head attention layer to facilitate the flow of information through the network. Residual connections allow the model to bypass certain layers, mitigating the vanishing gradient problem and enabling easier training of deeper networks. After adding the residual connections, layer normalization is applied to stabilize the activations across the different dimensions of the output tensor. Layer normalization normalizes the values along each feature dimension, ensuring that the model's outputs are consistent and easier to train.

Following the Add & Norm step, and as shown in FIG. 9, the output from the multi-head attention layer undergoes processing through a feed-forward neural network. This feed-forward network typically consists of two linear transformations with a non-linear activation function in between, such as ReLU (Rectified Linear Unit). The feed-forward network introduces additional non-linearities and enables the model to capture complex patterns in the data.

After the feed-forward processing, the LLM in FIG. 9 performs another Add & Norm step. Similar to the first Add & Norm step, residual connections are added to the output of the feed-forward network, followed by layer normalization to stabilize the activations. This ensures that the model can effectively incorporate the information learned from both the multi-head attention layer and the feed-forward network.

As further illustrated in FIG. 9, the LLM further processes outputs by leveraging different neural network components.

As shown, in FIG. 9, the output embedding is initially processed through a masked multi-head attention mechanism. This mechanism allows each token in the sequence to attend to all other tokens in the sequence, including itself, while preventing attending to future tokens. This is achieved by applying a mask to the attention scores, ensuring that each token can only attend to previous tokens in the sequence. Masked multi-head attention helps the model capture dependencies within the input sequence without peeking into the future.

Following the masked multi-head attention, the LLM passes the output through an Add & Norm layer. This layer adds the input of the masked multi-head attention layer to its output, facilitating the flow of information through the network via residual connections. After the addition operation, layer normalization is applied to stabilize the activations across different dimensions of the output tensor. Layer normalization ensures that the model's outputs are consistent and easier to train.

Next, and as shown in FIG. 9, the output of the Add & Norm layer undergoes processing through another multi-head attention mechanism. Unlike the masked multi-head attention, this step typically involves allowing each token to attend to all other tokens in the sequence without any masking. Multi-head attention helps the model capture global dependencies within the input sequence, enabling it to understand the context of each token more effectively.

Similar to the previous step, the output of the multi-head attention layer is combined with its input using residual connections in an Add & Norm layer. Layer normalization is then applied to stabilize the activations.

After the Add & Norm layer, the output passes through a feed-forward neural network. This network typically consists of two linear transformations with a non-linear activation function (such as ReLU) in between. The feed-forward network introduces additional non-linearities and enables the model to capture complex patterns in the data.

Following the feed-forward processing, another Add & Norm step is performed. This step adds the output of the feed-forward network to its input, followed by layer normalization to stabilize the activations.

The output of the Add & Norm layer is then passed through a linear transformation. This linear transformation projects the output into a high-dimensional space, preparing it for the final softmax activation.

After the linear transformation, softmax activation is applied to the output. Softmax converts the raw output scores into probabilities, ensuring that they sum up to 1. This allows the model to output a probability distribution over the possible tokens or classes in the output sequence.

The softmax activation produces output probabilities indicating the likelihood of each token in the output sequence. These probabilities represent the model's predictions for the next token in the sequence, allowing it to generate coherent and contextually appropriate text or code.

In summary, the example LLM illustrated in FIG. 9 combines input embeddings, positional encodings, attention mechanisms, linear layers, feed-forward layers, softmax activation, and output embeddings to process and generate human-like text based on the input they receive. Through training on large datasets, these models learn to understand and generate coherent and contextually appropriate text across a wide range of tasks. FIG. 9 illustrates example components and features of an LLM. An LLM may include any other combination of components and features.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

1. A system comprising:
at least one processor; and
a non-transitory computer readable medium storing instructions that, when executed by the at least one processor, cause the system to:
generate a member information embedding reflecting information stored in a member profile, wherein the member profile comprises a set of profile attributes for a member;
generate a member activity embedding reflecting member activity data associated with the member;
generate a member embedding based on the member information embedding and the member activity embedding;
generate a content item embedding, reflecting information about a content item;
determine a similarity score indicating a similarity between the content item embedding and the member embedding;
generate a target content item group based on determining that the similarity score satisfies a threshold similarity score; and
filter the member of the target content item group based on a filtering threshold.

2. The system of claim 1, further storing instructions that, when executed by the at least one processor, cause the system to:
generate the member information embedding by using a large language model to analyze raw text data from the member information, wherein a member information model comprises the large language model; and
generate the content item embedding by using the large language model to analyze raw text data reflecting information about the content item.

3. The system of claim 1, further storing instructions that, when executed by the at least one processor, cause the system to:
determine the filtering threshold for the target content item group; and
generating, based on the filtering threshold and the target content item group, filtered members comprising members within an entity that influence outcomes related to the content item.

4. The system of claim 1, further storing instructions that, when executed by the at least one processor, cause the system to generate the member activity embedding by using a multilayer perceptron to analyze member activity data corresponding with the member.

5. The system of claim 4, wherein the member activity data comprises at least one of content item engagement, publisher profile views, or publisher connections.

6. The system of claim 1, further storing instructions that, when executed by the at least one processor, cause the system to generate the member embedding by:
generating a member outreach embedding reflecting outreach data associated with the member; and
generate the member embedding based on the member information embedding, the member activity embedding, and the member outreach embedding.

7. The system of claim 1, further storing instructions that, when executed by the at least one processor, cause the system to generate the member embedding by:
using a wide and deep model to generate an output layer capturing interactions between the member information embedding and the member activity embedding, wherein the member embedding model comprises the wide and deep model; and
generating the member embedding based on the output layer by extracting a dense vector representation from the output layer.

8. The system of claim 1, further storing instructions that, when executed by the at least one processor, cause the system to provide, for display via a content item management user interface of a publisher device, the target content item group comprising the member.

9. The system of claim 1, further storing instructions that, when executed by the at least one processor, cause the system to provide, for display via a content item management user interface of a publisher device, filtered members corresponding to the target content item by:
determining a category of the content item;
generating, using an intent model, an intent score predicting a level of intent that the member has in the category of the content item;
generating an aggregated intent score based on intent scores from members of an entity, wherein the intent scores comprises the intent score and the entity comprises the member;
determining that an aggregated intent score corresponding to the entity satisfies an entity intent threshold score; and
providing, for display via the content item management user interface, a member within the entity as a filtered member.

10. A computer-implemented method comprising:
generating a member information embedding reflecting information stored in a member profile, wherein the member profile comprises a set of profile attributes for a member;
generating a member activity embedding reflecting member activity data associated with the member;
generating a member embedding based on the member information embedding and the member activity embedding;
generating a content item embedding reflecting information about a content item;
determining a similarity score indicating a similarity between the content item embedding and the member embedding;
generating a target content item group based on determining that the similarity score satisfies a threshold similarity score; and
filtering the member of the target content item group based on a filtering threshold.

11. The computer-implemented method of claim 10, further comprising generating the member information embedding by using a large language model to analyze raw text data from the member information, wherein a member information model comprises the large language model.

12. The computer-implemented method of claim 10, further comprising generating the member activity embedding by using a neural network to analyze member activity data corresponding with the member.

13. The computer-implemented method of claim 12, wherein the member activity data comprises at least one of content item engagement, publisher profile views, or publisher connections.

14. The computer-implemented method of claim 10, further comprising generating the content item embedding by using a large language model to analyze raw text data reflecting information about the content item.

15. The computer-implemented method of claim 14, wherein the raw text data reflecting information about the content item comprises at least one of a content item description, a publisher entity description, or advertisement text.

16. A non-transitory computer readable medium storing instructions that, when executed by at least one processor, cause the at least one processor to:
generate a member information embedding reflecting information stored in a member profile, wherein the member profile comprises a set of profile attributes for a member;
generate a member activity embedding reflecting member activity data associated with the member;
generate a member embedding based on the member information embedding and the member activity embedding;
generate a content item embedding, reflecting information about a content item;
determine a similarity score indicating a similarity between the content item embedding and the member embedding; and
generate a target content item group based on determining that the similarity score satisfies a threshold similarity score; and
filter the member of the target content item group based on a filtering threshold.

17. The non-transitory computer readable medium of claim 16, further storing instructions that, when executed by the at least one processor, cause the at least one processor to generate the member information embedding by using a large language model to analyze raw text data from the member information, wherein a member information model comprises the large language model.

18. The non-transitory computer readable medium of claim 16, further storing instructions that, when executed by the at least one processor, cause the at least one processor to generate the member activity embedding by using a neural network to analyze member activity data corresponding with the member.

19. The non-transitory computer readable medium of claim 18, wherein the member activity data comprises at least one of content item engagement, publisher profile views, or publisher connections.

20. The non-transitory computer readable medium of claim 16, further storing instructions that, when executed by the at least one processor, cause the at least one processor to generate the content item embedding by using a large language model to analyze raw text data reflecting information about the content item.
